(19) United States
(12) Patent Application Publication
(10) Pub. No.: US 2017/0081487 A1
(43) Pub. Date: Mar. 23, 2017

(54) A PROCESS FOR THE PREPARATION OF A FIBER REINFORCED COMPOSITE ARTICLE, THE COMPOSITE ARTICLES OBTAINED AND THE USE THEREOF

(71) Applicant: HUNTSMAN ADVANCED MATERIALS (SWITZERLAND) GMBH, Basel (CH)

(72) Inventors: Pavel SMOLKA, Fullinsdorf (CH); Josef GRINDLING, Pfeffingen (CH); Kenneth SCOBBIE, Henflingen (FR); Duncan HOWLAND, Hesingue (FR); Zoubair Cherkaoui, Hegenheim (FR)

(21) Appl. No.: 15/126,351

(22) PCT Filed: Mar. 2, 2015
(86) PCT No.: PCT/EP2015/054266

§ 371 Date: Sep. 15, 2016

(30) Foreign Application Priority Data
Mar. 28, 2014 (EP) 14162453.6

(51) Int. Cl. C08J 5/24; B29C 70/48; C08G 59/68; C08G 59/24; C08G 59/50

(52) U.S. Cl. CPC C08J 5/24; C08G 59/245; C08G 59/5026; C08G 59/687; B29C 70/48; C08J 2363/02; B29K 2063/00

(57) ABSTRACT

A process for the preparation of a fiber reinforced composite article comprising the steps of
a) providing a fibre preform in a mold,
b) injecting a multiple component thermosetting resin composition into the mold, wherein the resin composition comprises
(b 1) a liquid epoxy resin,
(b2) a curing agent comprising 1,3-bis(aminomethyl)cyclohexane, and
(b3) an accelerator comprising at least one compound selected from the group sulfonic acid and imidazolium salt of a sulfonic acid,
c) allowing the resin to impregnate the fiber preform,
d) curing the resin impregnated preform,
e) demolding the cured composite part,
   facilitates manufacturing of composite articles with reduced cycle times, said composite articles exhibit excellent mechanical properties, especially elongation and fracture toughness, and can be used for the construction of mass transportation vehicles, in particular in automotive and aerospace industry.

The present invention relates to a process for the preparation of fiber reinforced composite articles by using a multiple component thermosetting resin composition which facilitates manufacturing of composite articles with reduced cycle times. The composite articles obtained exhibit excellent mechanical properties and can be used for the construction of mass transportation vehicles, in particular in automotive and aerospace industry.

Significant effort in automotive industry is put into the production of lightweight cars to reduce CO₂-emission. One effort comprises complete or partial replacement of steel by aluminium. Another effort is replacement of aluminium or steel by composites, which further reduces the weight of cars. However, manufacturing composite body or even chassis parts for cars is demanding as only a few methods are suitable for making complex three-dimensional composite structures. As is the case with many other manufacturing processes, the economics of these composite manufacturing processes is heavily dependent on operating rates. For molding processes, operating rates are often expressed in terms of “cycle time”. “Cycle time” represents the time required to produce a part on the mold and prepare the mold to make the next part. Cycle time directly affects the number of parts that can be made on a mold per unit time. Longer cycle times increase manufacturing costs because overhead costs, for example, facilities and labor, are greater per part produced. If greater production capacity is needed, capital costs are also increased, due to the need for more molds and other processing equipment. In order to become competitive with other solutions, cycle times need to be shortened

One of the methods suitable for manufacturing complex three-dimensional structures is resin transfer molding (RTM) and its process variants, such as high-pressure resin transfer molding (HP-RTM) and high-pressure compression resin transfer molding (HP-CRTM), or vacuum-assisted resin transfer molding (VARTM) which is also designated vacuum-assisted resin infusion (VARI). Newly developed high-pressure RTM equipment technology allows injection of highly reactive resin compositions under high flow rate into the mold cavity. The combination of high-pressure pumps for dosing components of the fast reacting resin composition and their impingement mixing in self-cleaning high-pressure mixing heads guarantees precise component mixing along with fast materials injection into the mold at defined flow rates. The mold can be evacuated. Complex three dimensional cavities are filled faster, fiber preforms are properly impregnated and air entrapments are avoided.

In high-pressure compression resin transfer molding (HP-CRTM) the preform is placed into the mold cavity and the mold is closed partially, leaving a small gap between the upper mold surface and the fiber preform. The resin is introduced into this gap, flows easily over the preform and partially impregnates it. Once the required amount of resin has been injected into the gap, the mold is closed further and high compression pressure is applied to squeeze the resin into the preform, especially in the vertical z-direction. In this step, the preform is compacted to achieve the desired part thickness and fiber volume fraction. The part is demolded after curing. Quick resin injection into the defined gap and fast impregnation by applying compression force allows HP-CRTM to be used for even higher reactive resin compositions, thereby allowing even faster manufacturing of high-performance composites.

In resin transfer molding (RTM) and its process variants a fibrous reinforcement preform is placed in a mold, the mold is closed, the components of the resin composition are mixed before entering the mold inlet and after mixing injected into the mould cavity at the injection gate to impregnate the fiber preform and fill the mold. Since the resin is mixed with the catalyst or curing agent before or as it enters the mould cavity, the setting or curing process starts as the resin begins to flow into the mould. Therefore, it is essential that the resin reaches the edges of the mold cavity before it sets. Normally, the resin will be introduced unheated into a preheated mould, and the reactivity of the curing agent and the temperature of the mold will be adjusted so that the resin is able to flow into the edges of the mold, but begins to set immediately after it reaches the edges. At the injection gate the temperature initially drops sharply when the unheated resin is introduced. Once injection is completed, the temperature of the resin at the injection gate rises until it reaches a temperature at which it starts to cure. However, the resin which has reached the edges of the mold has already set at the time when the resin at the injection gate starts to cure. This may result in inhomogeneities in the composite article which may cause failure, in particular, in case of large sized composite articles, wherein complete filling of the mold and curing of the resin requires more time. Accordingly, RTM is rather limited to making small to medium sized parts.

In order to cope with these disadvantages RTM methods were developed which allow the manufacturing of composite articles in shorter cycle times. U.S. Pat. No. 5,906;782 suggests a process for molding products from thermosetting resins in which the flow of resin into a mold cavity begins with a first resin and changes before the mold is full to a second resin, wherein the first resin sets at a higher temperature than the second resin, i.e. the second resin being more catalyzed than the first resin. However, U.S. Pat. No. 5,906,782 fails to disclose suitable resin compositions which may be used to carry out the process described. S. Kim et al (International Journal of Heat and Mass Transfer 46, 2003, 3747-3754) suggest a numerical method which predicts the degree of cure distribution as a function of accelerator concentration at the injection gate. However, the filling pattern and RTM process modeled would result in cycle times which are too long for an economic use of RTM in automotive manufacturing and would prevent the person skilled in the art from employing the RTM process. Also S. Kim et al fail to suggest appropriate resin compositions. WO2008153542 describes an RTM process using epoxy resin compositions wherein gemdi(cyclohexylamine)-substituted alkanes are used as the hardener.

The processes according to the state of the art are currently not favourable for automotive manufacturing because cycle times are too long. The predominant contribution to cycle time is cure time of the resin composition. Hence if cure times can be shortened, cycle times will be reduced significantly. It is therefore desirable to have a rapid resin cure right after mold filling. During mold filling the viscosity of the resin composition is required to stay in a range which allows it to flow easily to completely impregnate the fibrous reinforcement preform without forming any voids or other defects. This time is referred to as “open time”, i.e. the time that is required for the polymer system to build enough molecular weight and crosslink density that it can no longer flow easily as a liquid after the components, i.e. prepolymer and hardener or catalyst, are mixed, at which time it can no longer be processed. The need for an adequate open time becomes increasingly important when making larger parts, because in these cases it can take up to several minutes to fill the mold.

On the other side, curing speed needs to be increased in order to achieve short cycle times. However, inappropriatly high curing speed may induce stress and cause mechanical failure due to inhomogeneities in the final composite article. Therefore, an ideal process which is suitable to manufacture in particular large composite articles would comprise a resin system with sufficient open time to allow for complete filling of the mold and impregnation of the fiber preform, which resin system cures rapidly after filling is complete, while avoiding inhomogeneities in the final composite article after cure.

Accordingly, it is an object of the present invention to provide a process for manufacturing fiber reinforced composite articles, which process allows manufacturing at short cycle times, and is at the same time useful for manufacturing larger parts without any defects and which process provides the above indicated properties to a large extent. Another objective is to provide the said fiber reinforced composite articles which exhibit excellent mechanical properties, especially elongation and fracture toughness. The said composite articles can be used for the construction of mass transportation vehicles, such as in automotive or aerospace industry, in particular, for the construction of cars.

Accordingly, the present invention relates to a process for the preparation of a fiber reinforced composite article comprising the steps of
a) providing a fibre preform in a mold,
b) injecting a multiple component thermosetting resin composition into the mold, wherein the resin composition comprises
(b1) a liquid epoxy resin,
(b2) a curing agent comprising 1,3-bis(aminomethyl)cyclohexane, and
(b3) an accelerator comprising at least one compound selected from the group sulfonic acid and imidazolium salt of a sulfonic acid,
c) allowing the resin to impregnate the fiber preform,
d) curing the resin impregnated preform,
e) demolding the cured composite part.

The process according to the present invention is useful to form various types of composite 130 products, and provides several advantages. Cure times tend to be very short, with good development of polymer properties, such as glass transition temperature Tg. This allows for faster demold times and shorter cycle times. The slower build-up of viscosity permits lower operating pressures to be used.

The liquid epoxy resin (b1) is a liquid at room temperature (˜20° C.). If required the epoxy resin contains an epoxy diluent component.

The epoxy diluent component is, for example, a glycidyl terminated compound. Especially preferred are compounds containing a glycidyl or □-methylglycidyl groups directly attached to an atom of oxygen, nitrogen, or sulfur. Such resins include polyglycidyl and poly(□-methylglycidyl) esters obtainable by the reaction of a substance containing two or more carboxylic acid groups per molecule with epichlorohydrin, glycerol dichlorohydrin, or □-methylepichlorohydrin in the presence of alkali. The polyglycidyl esters may be derived from aliphatic carboxylic acids, e.g. oxalic acid, succinic acid, adipic acid, sebacic acid, or dimerised or trimerised linoleic acid, from cycloaliphatic carboxylic acids such as hexahydro-phthalic, 4-methylhexahydrophthalic, tetrahydrophthalic, and 4-methyltetrahydrophthalic acid, or from aromatic carboxylic acids, such as phthalic acid, isophthalic acid, and terephthalic acid.

As the liquid epoxy resin (b1) there come into consideration epoxy resins which contain an average of at least 0.1 hydroxyl groups per molecule. The epoxy resin used herein comprises at least one compound or mixture of compounds having an average functionality of at least 2.0 epoxide groups per molecule. The epoxy resin or mixture thereof may have an average of up to 4.0 epoxide groups per molecule. It preferably has an average of from 2.0 to 3.0 epoxide groups per molecule.

The epoxy resin may have an epoxy equivalent weight of about 150 to about 1,000, preferably about 160 to about 300, more preferably from about 170 to about 250. If the epoxy resin is halogenated, the equivalent weight may be somewhat higher.

Other epoxide resins which may be used include polyglycidyl and poly(□-methylglycidyl) ethers obtainable by the reaction of substances containing per molecule, two or more alcoholic hydroxy groups, or two or more phenolic hydroxy groups, with epichlorohydrin, glycerol dichlorohydrin, or □-methylepichlorohydrin, under alkaline conditions or, alternatively, in the presence of an acidic catalyst with subsequent treatment with alkali.

Such polyglycidyl ethers may be derived from aliphatic alcohols, for example, ethylene glycol and poly(oxyethylene)glycols such as diethylene glycol and triethylene glycol, propylene glycol and poly(oxypropylene)glycols, propane-1,3-diol, butane-1,4-diol, pentane-1,5-diol, hexane-1,6-diol, hexane-2,4,6-triol, glycerol, 1,1,1-trimethylolpropane, and pentaerythritol; from cycloaliphatic alcohols, such as quinitol, 1,1 bis(hydroxymethyl)cyclohex-3-ene, bis(4-hydroxycyclohexyl)methane, and 2,2-bis(4-hydroxycyclohexyl)-propane; or from alcohols containing aromatic nuclei, such as N,N-bis-(2-hydroxyethyl)aniline and 4,4′-bis(2-hydroxyethylamino)diphenylmethane.

Preferably the polyglycidyl ethers are derived from substances containing two or more phenolic hydroxy groups per molecule, for example, resorcinol, catechol, hydroquinone, bis(4-hydroxyphenyl)methane (bisphenol F), 1,1,2,2-tetrakis(4-hydroxyphenyl)ethane, 4,4′-dihydroxydiphenyl, bis(4-hydroxyphenyl)sulphone (bisphenol S), 1,1-bis(4-hydroxylphenyl)-1-phenyl ethane (bisphenol AP), 1,1-bis(4-hydroxylphenyl)ethylene (bisphenol AD), phenol-formaldehyde or cresol-formaldehyde novolac resins, 2,2-bis(4-hydroxyphenyl)propane (bisphenol A), and 2,2-bis(3,5-dibromo-4-hydroxyphenyl)propane.

There may further be employed poly(N-glycidyl) compounds, such as are, for example, obtained by the dehydro chlorination of the reaction products of epichlorohydrin and amines containing at least two hydrogen atoms directly attached to nitrogen, such as aniline, n-butylamine, bis(4-aminophenyl)methane, bis(4-aminophenyl)sulphone, and bis(4-methylaminophenyl)methane. Other poly(N-glycidyl) compounds that may be used include triglycidyl isocyanurate, N,N′-diglycidyl derivatives of cyclic alkylene ureas such as ethyleneurea and 1,3-propyleneurea, and N,N′-diglycidyl derivatives of hydantoins such as 5,5-dimethylhydantoin.

Epoxide resins obtained by the epoxidation of cyclic and acrylic polyolefins may also be employed, such as vinylcyclohexene dioxide, limonene dioxide, dicyclopentadiene dioxide, 3,4-epoxydihydrodicyclopentadienyl glycidyl ether, the bis(3,4-epoxydihydrodicyclopenta-dienyl)ether of ethylene glycol, 3,4-epoxycyclohexylmethyl 3,4′-epoxycyclohexane-carboxylate and its 6,6′-dimethyl derivative, the bis(3,4-epoxycyclohexanecarboxylate) of ethylene glycol, the acetal formed between 3,4-epoxycyclohexanecarboxyaldehyde and 1,1-bis(hydroxymethyl)-3,4-epoxycyclohexane, bis(2,3-epoxycyclopentypether, and epoxidized butadiene or copolymers of butadiene with ethylenic compounds such as styrene and vinyl acetate. In one embodiment of the present invention, the liquid epoxy resin (b1) is the diglycidyl ether of a polyhydric phenol represented by formula (1)

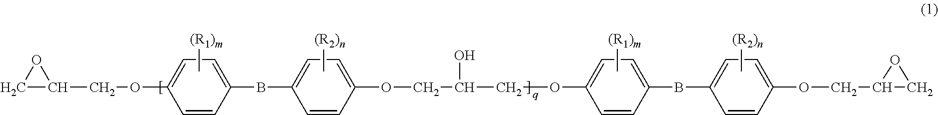

wherein (R₁)ₘ independently denotes m substituents selected from the group consisting of C₁- C₄alkyl and halogen, (R₂)ₙ independently denotes n substituents selected from from the group consisting of C₁-C₄alkyl and halogen, each B independently is —S—, —S—S—, —SO—, —SO₂—, —CO₃—, —CO—, —O—, or a C₁-C₆(cylo)alkylene radical. Each m and each n are independently an integer 0, 1, 2, 3 or 4 and q is a number of from 0 to 5. q is the average number of hydroxyl groups in the epoxy resin of formula (1). R₁ and R₂ in the meaning of halogen are, for example, chlorine or bromine. R₁ and R₂ in the meaning of C₁-C₄alkyl are, for example, methyl, ethyl, n-propyl or iso-propyl. B independently in the meaning of a C₁-C₆(cylo)-alkylene radical is, for example, methylene, 1,2-ethylene, 1,3-propylene, 1,2-propylene, 2,2-propylene, 1,4-butylene, 1,5-pentylene, 1,6-hexylene or 1,1-cyclohexylene. Preferably, each B independently is methylene, 2,2-propylene or —SO₂—. Preferably, each m and each n are independently an integer 0, 1 or 2, more preferably 0. Examples of suitable epoxy resins include diglycidyl ethers of dihydric phenols such as bisphenol A, bisphenol F and bisphenol S, and mixtures thereof. Preferred epoxy resins of this type are those in which q is at least 0.1, especially those in which q is from 0.1 to 2.5. Epoxy resins of this type are commercially available, including diglycidyl ethers of bisphenol A resins. Suitable halogenated epoxy resins, wherein at least one of R₁ and R₂ are halogen, are described in, for example, in U.S. Pat. No. 4,251,594, U.S. Pat. No. 4,661,568, U.S. Pat. No. 4,713,137 and U.S. Pat. No. 4,868,059, and Lee and Neville, Handbook of Epoxy Resins, McGraw-Hill (1982), all of which are incorporated herein by reference.

The epoxy resins indicated are either commercially available or can be prepared according to the processes described in the cited documents.

In a preferred embodiment of the present invention diglycidyl ethers of polyhydric phenols as given by formula (1) are used, wherein the radicals have the meanings and preferences given above. In a more preferred embodiment, the epoxy resin of formula (1) is a diglycidyl ether of bisphenol A.

Appropriately, the epoxy resin (b1) is used in an amount of from 60 to 90 weight %, preferably 75 to 90 weight % and more preferably 80 to 85 weight % based on the total weight of the thermosetting resin composition.

According to the process of the present invention the curing agent (b2) comprises 1,3-bis(aminomethyl)cyclo-hexane. 1,3-bis(aminomethyl)cyclohexane is used alone or in combination with other curing agents, for example, primary or secondary amines. The identity of many of these amines and their curing mechanisms are discussed in Lee and Neville, Handbook of Epoxy Resins, McGraw-Hill (1982).

As suitable amines for use in combination with 1,3-bis(aminomethyl)cyclohexane, there may be mentioned aliphatic, cycloaliphatic or araliphatic primary and secondary amines, including mixtures of these amines. Typical amines include monoethanolamine, N-aminoethyl ethanolamine, ethylenediamine, hexamethylenediamine, trimethylhexamethylenediamines, methylpentamethylenediamines, diethylenetriamine, triethylenetetramine, tetraethylene-pentamine, N,N-dimethylpropylenediamine-1,3, N,N-diethylpropylenediamine-1,3, bis(4-amino-3-methylcyclohexyl)methane, bis(p-aminocyclohexyl)methane, 2,2-bis-(4-aminocyclohexyl)propane, 3,5,5-trimethyl-s-(aminomethyl)cyclohexylamine, 1,2-diaminocyclohexane, 1,4-diaminocyclohexane, 1,4-bis(aminomethyl)cyclohexane, N-aminoethylpiperazine, m-xylene diamine, norbornene diamine, 3(4),8(9)-bis-(aminomethyl)-tricyclo-[5.2.1.02,6]decane (TCD-diamine), and isophorone diamine. Preferred amines include 2,2,4-trimethylhexamethylenediamine, 2,4,4-trimethylhexamethylenediamine, 2-methylpentamethylenediamine, diethylenetriamine, triethylenetetramine, tetraethylene-pentamine, 1,2-diaminocyclohexane, bis(p-aminocyclohexyl)methane, m-xylene diamine, norbornene diamine, 3(4),8(9)-bis-(aminomethyl)-tricyclo-[5.2.1.02,6]decane (TCD-diamine), isophorone diamine and 1,4-bis(aminomethyl)cyclohexane. Especially preferred amines include diethylenetriamine, triethylenetetramine, tetraethylenepentamine, 1,2-diaminocyclo-hexane, m-xylene diamine, norbornene diamine, 3(4),8(9)-bis-(aminomethyl)-tricyclo-[5.2.1.02,6]decane (TCD-diamine) and isophorone diamine.

Preferably, the curing agent (b2) is 1,3-bis(aminomethyl)cyclohexane, which is used as the single curing agent (b2), and not applied in admixture with other curing agents.

Appropriately, the curing agent (b2) is used in an amount of from 10 to 40 weight %, preferably 10 to 25 weight % and more preferably 15 to 20 weight % based on the total weight of the thermosetting resin composition.

The accelerator (b3) comprises at least one compound selected from the group sulfonic acid and imidazolium salt of a sulfonic acid.

According to one embodiment of the present invention at least one sulfonic acid is used as the accelerator (b3), for example, one sulfonic acid or two different sulfonic acids. Suitable sulfonic acids are, for example, methane sulfonic acid and toluene sulfonic acids, such as p-toluene sulfonic acid, and, preferably, as p-toluene sulfonic acid. The sulfonic acid is used alone or in combination with other accelerators suitable to increase the cure rate of epoxy resin systems, for example, guanidines, calcium nitrate, imidazoles, cyanamide compounds, such as dicyanamide, dicyandiamide and cyanamide, boron halide complexes and tertiary amines.

In another embodiment of the present invention at least one imidazolium salt of a sulfonic acid is used as the accelerator (b3), for example, one imidazolium salt or two different imidazolium salts. The imidazolium salt is used alone or in combination with other accelerators suitable to increase the cure rate of epoxy resin systems, for example, guanidines, calcium nitrate, imidazoles, cyanamide compounds, such as dicyanamide, dicyandiamide and cyanamide, boron halide complexes and tertiary amines.

The imidazolium salt of a sulfonic acid is advantageously provided as an ionic liquid, so that it can be processed in accordance with the inventive process by means of the apparatus described hereafter, for example, as a liquid imidazolium salt of p-toluene sulfonic acid or methane sulfonic acid, such as 1-methylimidazolium p-toluene sulfonate or 1,3-dimethylimidazolium methyl sulfate.

Appropriately, the accelerator (b3) is used in an amount of from 0.05 to 5 weight %, preferably of from 0.1 to 3 weight % and more preferably of from 0.15 to 2.0 weight % based on the total weight of the thermosetting resin composition.

Preferably, the accelerator (b3) is p-toluene sulfonic acid (PTSA), a liquid imidazolium salt of p-toluene sulfonic acid, or methane sulfonic acid, such as 1-methylimidazolium p-toluene sulfonate or 1,3-dimethylimidazolium methyl sulfate, which is used as the single accelerator (b3), and not applied in admixture with other accelerators. p-toluene sulfonic acid is commercially available, for example, as the monohydrate. Liquid imidazolium salts of sulfonic acids are commercially available, for example, from EMD Chemicals Inc., or can be prepared by mixing stoichiometric (equimolar) amounts of a mono- or disubstituted imidazole derivative and sulfonic acid. Preferably, 1-methylimidazolium p-toluene sulfonate is used as an ionic liquid.

In one embodiment of the present invention, the process is a resin transfer molding process (RTM). In one interesting embodiment of the present invention, the process is a high-pressure resin transfer molding process (HP-RTM), or a high-pressure compression resin transfer molding process (HP-CRTM). In another interesting embodiment of the present invention, the process is a vacuum-assisted resin transfer molding process (VARTM), also designated vacuum-assisted resin infusion process (YARD).

The resin transfer molding processes indicated above, generally, involve two basic procedures, (i) fabricating a fiber preform in the shape of a finished article and (ii) impregnating the preform with a thermosetting resin, commonly called a matrix resin.

The first step in resin transfer molding processes is to fabricate a fiber preform in the shape of the desired article. The preform generally comprises a plurality of fabric layers or plies that impart the desired reinforcing properties to a resulting composite article. Once the fiber preform has been fabricated, the preform is placed in a cavity mold. In the second step the mold is closed and the matrix resin is injected into the mold to initially wet and impregnate the preform. In certain process variants the matrix resin is injected under pressure into the mold and afterwards cured to produce the final composite article. In the VARTM or VARI process, the preform is covered by flexible sheet or liner. The flexible sheet or liner is clamped onto the mold to seal the preform in an envelope. A catalyzed matrix resin is then introduced into the envelope to wet the preform. A vacuum is applied to the interior of the envelope via a vacuum line to collapse the flexible sheet against the preform. The vacuum draws the resin through the preform and helps to avoid the formation of air bubbles or voids in the finished article. The matrix resin cures while being subjected to the vacuum. The application of the vacuum draws off any fumes produced during the curing process.

In a particular embodiment of the inventive process, injection of the thermosetting resin composition into the mold comprises varying the concentration of accelerator (b3) in the course of injecting the resin to increase the cure rate of the resin composition, wherein injection is initiated with a resin composition which contains no accelerator (b3) or the accelerator (b3) in a low concentration, and wherein injection is completed with a resin composition which contains the accelerator (b3) in a high concentration.

The variation from a resin composition which initially contains no accelerator (b3) or the accelerator (b3) in a low concentration to a resin composition which finally contains the accelerator (b3) in a high concentration is accomplished as required, for example, by a linear or piecewise linear increase according to the concentration/time-dependency schemes illustrated by S. Kim et al (International Journal of Heat and Mass Transfer 46, 2003, 3747-3754). The linear concentration/time-dependency scheme is depicted by a straight line of a positive gradient, whereas the piecewise linear concentration/time-dependency scheme is depicted, for example, by at least two meeting straight lines with distinct positive gradients. If appropriate, the change may also be accomplished in one or more discrete steps, wherein the concentration of the accelerator (b3) in the resin is increased stepwise, for example, by a sudden increase of the concentration which is followed by a phase, wherein the concentration of the accelerator (b3) ist kept constant. This scheme is appropriately considered an embodiment of the piecewise linear concentration/time-dependency scheme. Moreover, the variation may be accomplished in accordance with a non-linear scheme, for example, an exponential, quadratic or cubic growth scheme.

Appropriately, the resin composition which contains no accelerator (b3) or the accelerator (b3) in a low concentration comprises an amount of accelerator (b3), for example, of from 0 to 0.75 weight %, preferably of from 0 to 0.5 weight %, and more preferably of from 0 to 0.25 weight %, based on the total weight of the thermosetting resin composition. Appropriately, the resin composition which contains the accelerator (b3) in a high concentration comprises an amount of accelerator (b3), for example, of from 0.75 to 5 weight %, preferably of from 0.5 to 3 weight %, and more preferably of from 0.25 to 2.5 weight %, based on the total weight of the thermosetting resin composition. It is understood that each of the highest amounts of accelerator (b3) indicated for the resin composition which contains the accelerator (b3) in a low concentration is lower than each of the lowest amounts of accelerator (b3) indicated for the resin composition which contains the accelerator (b3) in a high concentration.

The process which comprises varying the concentration of accelerator (b3) in the course of injecting the resin into the mold is referred to hereafter as VARICAT process.

An apparatus to carry out the process according to the present invention, in particular, the VARICAT process, comprises a reservoir for each of the components (b1), (b2) and (b3), feed lines which connect the reservoirs with the mixing head and the inlet of the mold, and pumps which provide for transportation of each of the components from their reservoirs to the mixing head. The mixing head is, for example, a static mixer or a self-cleaning high pressure mixing head, which is placed at the injection gate of the mold, and provides for mixing of the components before the resin composition enters the mold. The accelerator (b3) is, for example, feeded into the feed line of the curing agent (b2) before the curing agent (b2) is feeded into the mixing head, i.e. before the feed line of the curing agent (b2) arrives at the mixing head. In another embodiment, the accelerator (b3) is, for example, feeded into the feed line of the liquid epoxy resin (b1), before the liquid epoxy resin (b1) is feeded into the mixing head, i.e. before the feed line of the liquid epoxy resin (b1) arrives at the mixing head. In yet another embodiment, the accelerator (b3) is, for example, feeded directly into the mixing head, separately from the liquid epoxy resin (b1) and the curing agent (b2), i.e. all components are feeded by separate feed lines which, for example, join at the mixing head. Appropriately, the pumps are controlled by a computer system equipped with suitable software to operate the pumps, i.e. control the pump rate. The software controls the pump rate of each pump in order to appropriately dose each of the components into the mixing head in accordance with the desired concentration/time-dependency scheme. Suitable software is commercially available.

In case the accelerator (b3) is a solid, such as p-toluene sulfonic acid, it is advantageously dissolved, for example, in the liquid curing agent (b2) in appropriate amounts to provide a solution which can be processed in accordance with the inventive process by means of the apparatus described above, for example, by feeding the solution of accelerator (b3) in curing agent (b2) separately from the liquid epoxy resin (b1) and the curing agent (b2).

In one embodiment, the concentration of the liquid epoxy resin (b1) in the thermosetting resin composition is kept constant in the course of injecting the resin into the mold, while the concentration of the accelerator is increased as described above. In another embodiment, the concentration of the curing agent (b2) in the thermosetting resin composition is kept constant in the course of injecting the resin into the mold, while the concentration of the accelerator is increased as described above. In still another embodiment, the concentration of the liquid epoxy resin (b1) and the concentration of the curing agent (b2) in the thermosetting resin composition are kept constant in the course of injecting the resin into the mold, while the concentration of the accelerator is increased as described above.

In a particular embodiment of the present invention, the inventive process is a VARICAT process, wherein the multiple component thermosetting resin composition comprises (b1) a diglycidylether of bisphenol A as the liquid epoxy resin, optionally used in admixture with other liquid epoxy resins, preferably a diglycidylether of bisphenol A, (b2) 1,3-bis(aminomethyl)cyclohexane as the curing agent, optionally used in admixture with other curing agents, preferably 1,3-bis(aminomethyl)cyclohexane, (b3) p-toluene sulfonic acid, a liquid imidazolium salt of p-toluene sulfonic acid, or methane sulfonic acid as the accelerator, optionally used in admixture with other accelerators, preferably p-toluene sulfonic acid, a liquid imidazolium salt of p-toluene sulfonic acid, or methane sulfonic acid.

In an especially preferred embodiment of the present invention, the inventive process is a VARICAT process, wherein the multiple component thermosetting resin composition comprises
(b1) a diglycidylether of bisphenol A,
(b2) 1,3-bis(aminomethyl)cyclohexane,
(b3) p-toluene sulfonic acid, or a liquid imidazolium salt of p-toluene sulfonic acid, preferably p-toluene sulfonic acid, 1-methylimidazolium p-toluene sulfonate, or 1,3-dimethylimidazolium methyl sulfate.

In case the solid accelerator (b3), such as p-toluene sulfonic acid, is dissolved in the liquid curing agent (b2) to provide a processable, concentrated solution, the shelf life may be insufficient, and precipitation may occur during transportation or storage in the reservoir. Such precipitation of the accelerator (b3) is not desired, since it may result in failure of pumps and clogging of feed lines. Also the cure kinetics of the thermosetting resin composition obtained may be adversely affected and the composite article prepared therefrom may become inhomogeneous. Suprisingly, it has been found that the solubility of p-toluene sulfonic acid in 1,3-bis(aminomethyl)cyclohexane and the shelf life of the solution is considerably improved by addition of small amounts of water. Advantageously, water is added to the liquid curing agent (b2) before or after the accelerator (b3) is dissolved. The amount of water added is, for example, in the range of from 0.5 to 1.5 weight %, preferably of from 0.8 to 1.2 weight %, based on the total weight of the solution of the sulfonic acid in the curing agent (b2). It is furthermore surprising and was not expected that the water added to improve solubility and shelf life does neither deteriorate the cure kinetics of the thermosetting resin composition nor the properties of the final composite articles prepare therefrom. By providing the accelerator (b3) in a stable, concentrated solution, it can be more effectively dosed during processing in accordance with the inventive process, for example, by means of the apparatus described above.

In another embodiment, stable, concentrated solutions of accelerator (b3) in the liquid curing agent (b2) with a very good shelf life are prepared by applying the sulfonic acid as an ionic liquid, for example, an imidazolium salt of a sulfonic acid. Preferably, the ionic liquid is an imidazolium salt of p-toluene sulfonic acid or methane sulfonic acid, for example, 1-methylimidazolium p-toluene sulfonate or 1,3-dimethylimidazolium methyl sulfate. Preferably, 1-methylimidazolium p-toluene sulfonate is used as an ionic liquid.

The term concentrated solution shall mean an amount of accelerator (b3), for example, p-toluene sulfonic acid, in the curing agent (b2) in the amount of up to 55 weight %, preferably up to 50 weight %, based on the total weight of the concentrated solution of accelerator (b3) in the curing agent (b2) at room temperature.

In yet another embodiment, the ionic liquid can be applied directly as the accelerator (b3) in accordance with the inventive process without being dissolved in the liquid curing agent (b2).

According to the process of the present invention, curing step d), i.e. curing of the resin impregnated preform, is carried out under isothermal conditions at a temperature of from 80 to 140° C., preferably of from 105 to 125° C.,

The process according to the present invention allows for uniform cure for a given mold geometry, cure cyle and preform. Fiber reinforced composite articles with excellent mechanical properties, especially elongation and fracture toughness and a high Tg can be prepared within a cycle time of less than 5 minutes, preferably less than 4 minutes and most preferably less than 3 minutes. The resin composition applied according to inventive process has an appropriate open time after mixing of the components at the injection gate, but the ability to cure rapidly without the need of post-curing.

The present invention is also directed to the composite articles obtained by the inventive process.

Moreover, the present invention is directed to the use of the composite articles obtained according to the inventive process for the construction of mass transportation vehicles, in particular in automotive and aerospace industry.

The following Examples serve to illustrate the invention. Unless otherwise indicated, the temperatures are given in degrees Celsius, parts are parts by weight and percentages relate to % by weight. Parts by weight relate to parts by volume in a ratio of kilograms to litres.

### EXAMPLE 1

Test specimens are prepared by filling into a mold a composition of 83.33 parts of bisphenol A diglycidylether (ARALDITE® LY 1135-1 A), 16.17 parts of 1,3-bis(aminomethyl)cyclo-hexane and 0.50 parts of p-toluene sulfonic acid mono hydrate (PTSAx H₂O). The compositions are cured at 110° C. During curing viscosity build-up at 110° C., gelation time and DSC isotherm are measured.

### EXAMPLE 2

Test specimens are prepared by filling into a mold a composition of 82.17 parts of bisphenol A diglycidylether (ARALDITE® LY 1135-1 A) and 16.05 parts of 1,3-bis(aminomethyl)cyclo-hexane and 1.78 parts of p-toluene sulfonic acid mono hydrate (PTSAx H₂O). The compositions are cured at 110° C. During curing viscosity build-up at 110° C., gelation time and DSC isotherm are measured.

### COMPARATIVE EXAMPLE 1

Test specimens are prepared by filling into a mold a composition of 83.68 parts of bisphenol A diglycidylether (ARALDITE® LY 1135-1 A) and 16.32 parts of 1,3-bis(aminomethyl)cyclo-hexane. The compositions are cured at 110° C. During curing viscosity build-up at 110° C., gelation time and DSC isotherm are measured.

TABLE 1
Gelation time at 110° C.

| Example | PTSAx H₂O [wt %]* | Gel time at 110° C. [s] |
|---|---|---|
| Comparative Example 1 | 0 | 149 |
| Example 1 | 0.5 | 99 |
| Example 2 | 1.78 | 44 |

*wt % based on the total weight of the thermosetting resin composition

TABLE 2
Viscosity build-up at 110° C. (time to 300 mPa s)

| Example | PTSAx H₂O [wt %]* | time at 110° C. [s] |
|---|---|---|
| Comparative Example 1 | 0 | 76 |
| Example 1 | 0.5 | 45 |
| Example 2 | 1.78 | 26 |

*wt % based on the total weight of the thermosetting resin composition

TABLE 3
Viscosity build-up at 110° C. (time to 600 mPa s)

| Example | PTSAx H₂O [wt %]* | time at 110° C. [s] |
|---|---|---|
| Comparative Example 1 | 0 | 84 |
| Example 1 | 0.5 | 52 |
| Example 2 | 1.78 | 30 |

*wt % based on the total weight of the thermosetting resin composition

TABLE 4
Differential Scanning Calorimetry (DSC) isotherm
at 110° C. (time for 95% conversion)

| Example | PTSAx H₂O [wt %]* | time at 110° C. [s] |
|---|---|---|
| Comparative Example 1 | 0 | 355 |
| Example 1 | 0.5 | 235 |
| Example 2 | 1.78 | 167 |

*wt % based on the total weight of the thermosetting resin composition

The data given in Tables 1 to 4 demonstrate that viscosity build-up, gelation time and conversion can be easily controlled by varying the amount of the accelerator p-toluene sulfonic acid in the thermosetting composition.

Viscosity build-up is measured on a Brookfield CAP 2000+(plate-cone #1). Gelation time is measured manually on a hot plate using an electronic clock. Differential Scanning calorimetry is measured on a Mettler DSC apparatus (30 minutes at 110° C.).

TABLE 5
Glass transition temperature (Tg) after 3 min cure at at 110° C.

| | PTSAx H₂O | Tg [° C.] | Tg [° C.] |
|---|---|---|---|
| Example | [wt %]* | onset | tan□ |
| Comparative Example 1 | 0 | 113.0 | 128.0 |
| Example 1 | 0.5 | 102.3 | 125.3 |
| Example 2 | 1.78 | 106.4 | 129.1 |

*wt % based on the total weight of the thermosetting resin composition

TABLE 6
Glass transition temperature (Tg) after 2 h cure at 180° C.

| | | Tg [° C.] |
|---|---|---|
| Example | PTSAx H₂O [wt %]* | tan□ |
| Comparative Example 1 | 0 | 148 |
| Example 1 | 0.5 | 147 |
| Example 2 | 1.78 | 151 |

*wt % based on the total weight of the thermosetting resin composition

The data given in Tables 5 and 6 demonstrate that the glass transition temperature is not materially affected by varying the amount of the accelerator p-toluene sulfonic acid in the thermosetting composition.

Glass transition temperature (Tg) of test specimens prepared as 6 plies CFRP (carbon fiber reinforced polymer) composite (40 weight % resin content) in accordance with the Examples above is measured by Dynamic Mechanical Analysis (DMA) on a Perkin Elmer 8000 (range: 20 to 210° C. at 10° C. min⁻¹).

TABLE 7
Solubility of PTSAx H₂O in curing agent (b2) at 23° C.

| PTSAx H₂O | | | |
|---|---|---|---|
| [wt %]* | 1,3-BAC^{a)} | 1,4-BAC | 1,3-BAC/1,4-BAC = 1/1 |
| 3.0 | Yes^{b)} | No | No |
| 10.0 | Yes^{b)} | No | No |
| 20.0 | Yes^{c)} | | |
| 30.0 | Yes^{c)} | | |

*wt % based on the total weight of PTSAx H₂O in curing agent (b2)
^{a)}BAC: bis(aminomethyl)cyclohexane
^{b)}no precipitation observed after prolonged storage at ambient temperature
^{c)}no precipitation observed after prolonged storage at ambient temperature; contains 1.0 wt % water based on the total weight of PTSAx H₂O in curing agent (b2)

The data given in Table 7 demonstrate that concentrated solutions of p-toluene sulfonic acid in 1,3-bis(aminomethyl)cyclohexane are shelf stable.

### EXAMPLE 3

Diglycidyl ether of bisphenol A (ARALDITE® LY 1135-1 A) is charged to a reservoir and heated to 70° C. with stirring. A solution of 30 parts of p-toluene sulfonic acid mono hydrate (PTSAx H₂O) in 70 parts of 1,3-bis(aminomethyl)cyclohexane is charged to a reservoir and heated to 50° C. with stirring. 1,3-bis(aminomethyl)cyclohexane is charged to a reservoir and heated to 50° C. with stirring.

A pre-formed carbon-fibre reinforcement mat is then positioned manually into a vented mold of a car roof, and the mold is closed. The diglycidyl ether of bisphenol A, the curing agent and the concentrated solution of p-toluene sulfonic acid mono hydrate in the curing agent are injected into the mold through a static mixer dispensing unit or a self-cleaning high pressure mixing head. Air is removed from upper side vents of the mold, or the mold is evacuated. The weight ratio of epoxy resin/curing agent/p-toluene sulfonic acid is 83.33/16.17/0.5. Pouring time is 40 sec. The mold is preheated to 110° C. and maintained at that temperature during the curing process. Demold time is about 2.5 minutes after end of pouring. The Tg of the polymer phase for a typical part made in this manner is about 115° C. Part thickness is approximately 2 mm. Similar results are obtained when the epoxy resin composition is used to make articles for cars of a different geometry.

### EXAMPLE 4

Diglycidyl ether of bisphenol A (ARALDITE® LY 1135-1 A) is charged to a reservoir and heated to 70° C. with stirring. A solution of 30 parts of p-toluene sulfonic acid mono hydrate (PTSAx H₂O) in 70 parts of 1,3-bis(aminomethyl)cyclohexane is charged to a reservoir and heated to 50° C. with stirring. 1,3-bis(aminomethyl)cyclohexane is charged to a reservoir and heated to 50° C. with stirring.

A pre-formed carbon-fibre reinforcement mat is then positioned manually into a vented mold of a car side frame, and the mold is closed. The diglycidyl ether of bisphenol A, the curing agent and the concentrated solution of p-toluene sulfonic acid mono hydrate in the curing agent are injected into the mold through a static mixer dispensing unit or a self-cleaning high pressure mixing head. Air is removed from upper side vents of the mold, or the mold is evacuated. The weight ratio of epoxy resin/curing agent/p-toluene sulfonic acid is 83.61/16.39/0.0 at the beginning of the injection and linearly increased to 81.10/15.90/3.0 at the end of the injection. Pouring time is 40 sec. The mold is preheated to 110° C. and maintained at that temperature during the curing process. Demold time is about 1.5 minutes after end of pouring. The Tg of the polymer phase for a typical part made in this manner is about 115° C. Part thickness is approximately 2 mm. Similar results are obtained when the epoxy resin composition is used to make articles for cars of a different geometry.

### EXAMPLES 5 to 11

Test specimens (NEAT 4 mm board) are prepared by filling into a mold a composition of ARALDITE® LY 1135-1 A (bisphenol A diglycidylether: Bis A), 1,3-bis(aminomethyl)cyclo-hexane (1,3-BAC) and 1-Methylimidazolium p-toluene sulfonate as an ionic liquid (IL), which is prepared by mixing equimolar amounts of p-toluene sulfonic acid mono hydrate (PTSAx H₂O) and 1-Methylimidazole. The amount of each component is given in Table 8. Epoxy equivalent weight of ARALDITE® LY 1135-1 A is 181. The compositions are cured as indicated below. Viscosity build-up at 110° C., gelation time, glass transition temperature and some mechanical properties are determined.

TABLE 8
Compositions according to Examples 5 to 11

| | Example | | | | | | |
|---|---|---|---|---|---|---|---|
| | 5** | 6 | 7 | 8 | 9 | 10 | 11 |
| Bis A* | 83.61 | 83.19 | 82.77 | 82.35 | 81.93 | 81.51 | 81.10 |
| 1,3-BAC* | 16.39 | 16.31 | 16.23 | 16.15 | 16.07 | 15.99 | 15.90 |
| IL* | 0.00 | 0.50 | 1.00 | 1.5 | 2.0 | 2.5 | 3.0 |

*wt % based on the total weight of the thermosetting resin composition
**Comparative Example 5

TABLE 9
Gelation time at 110° C.*

| | Example | | | | | | |
|---|---|---|---|---|---|---|---|
| | 5** | 6 | 7 | 8 | 9 | 10 | 11 |
| Gelation | 143 | 89 | 72 | 61 | 55 | 50 | 44 |
| time [s] | | | | | | | |

*Gelation time is measured manually on a hot plate using an electronic clock
**Comparative Example 5

TABLE 10
Glass transition temperature Tg (DSC) according to ISO 11357-2*

| | Example | | | | | | |
|---|---|---|---|---|---|---|---|
| | 5** | 6 | 7 | 8 | 9 | 10 | 11 |
| 1^{st} run | 136.9 | 136.4 | 136.2 | 136.5 | 135.1 | 135.3 | 134.7 |
| onset [° C.] | | | | | | | |
| 2^{nd} run | 141.8 | 139.9 | 140.0 | 140.0 | 138.6 | 138.0 | 137.2 |
| onset [° C.] | | | | | | | |
| 1^{st} run | 138.7 | 138.3 | 138.4 | 138.5 | 137.1 | 137.4 | 136.9 |
| midpoint | | | | | | | |
| [° C.] | | | | | | | |
| 2^{nd} run | 146.6 | 145.1 | 144.9 | 145.2 | 143.4 | 142.7 | 142.4 |
| midpoint | | | | | | | |
| [° C.] | | | | | | | |

*Curing pattern: RT to 80° C. at 2°/min, 1 h at 80° C., 80° C. to 120° C. at 2°/min, 4 h at 120° C., cooling; Differential Scanning Calorimetry carried out on a Mettler SC 822^{e} (range: 20 to 250° C. at 10° C. min⁻¹)
**Comparative Example 5

TABLE 11
Tensile strength according to ISO 527-1/1B*

| | Example | | | | | | |
|---|---|---|---|---|---|---|---|
| | 5** | 6 | 7 | 8 | 9 | 10 | 11 |
| Modulus [MPa] | 2612 | 2617 | 2641 | 2630 | 2674 | 2671 | 2717 |
| Utimate Strength [MPa] | 78.03 | 78.05 | 78.06 | 78.57 | 78.89 | 79.04 | 79.82 |
| Elongation at break [° C.] | 5.95 | 5.49 | 5.44 | 5.64 | 5.68 | 5.57 | 5.67 |

*Curing pattern: RT to 80° C. at 2°/min 1 h at 80° C., 80° C. to 120° C. at 2°/min, 4 h at 120° C., cooling
**Comparative Example 5

TABLE 12
Fracture toughness according to ISO 13586*

| | Example | | | | | | |
|---|---|---|---|---|---|---|---|
| | 5** | 6 | 7 | 8 | 9 | 10 | 11 |
| K1C [MPa | 0.748 | 0.753 | 0.732 | 0.776 | 0.764 | 0.74 | 0.722 |
| √m] | | | | | | | |
| G1C [kJ m⁻²] | 0.225 | 0.228 | 0.213 | 0.229 | 0.23 | 0.212 | 0.207 |

*Curing pattern: RT to 80° C. at 2°/min, 1 h at 80° C., 80° C. to 120° C. at 2°/min, 4 h at 120° C., cooling
**Comparative Example 5

The data given in Table 9 demonstrate that the gelation time can be easily controlled by varying the amount of the accelerator 1-Methylimidazolium p-toluene sulfonate in the thermosetting composition.

The data given in Tables 10 to 12 demonstrate that the glass transition temperature and the mechanical properties of the test specimens are not materially affected by varying the amount of the 1-Methylimidazolium p-toluene sulfonate in the thermosetting composition.

1. A process for the preparation of a fiber reinforced composite article comprising the steps of
a) providing a fibre preform in a mold,
b) injecting a multiple component thermosetting resin composition into the mold, wherein the resin composition comprises
(b1) a liquid epoxy resin,
(b2) a curing agent comprising 1,3-bis(aminomethyl)cyclohexane, and
(b3) an accelerator comprising at least one compound selected from the group consisting of sulfonic acid and imidazolium salt of a sulfonic acid,
c) allowing the resin to impregnate the fiber preform,
d) curing the resin impregnated preform, and
e) demolding the cured composite part.

2. The process according to claim 1, wherein the liquid epoxy resin (b1) is a diglycidylether of bisphenol A.

3. The process according to claim 1, wherein the curing agent (b2) is 1,3-bis(aminomethyl)cyclohexane.

4. The process according to claim 1, wherein the accelerator (b3) is p-toluene sulfonic acid, a liquid imidazolium salt of p-toluene sulfonic acid, or methane sulfonic acid.

5. The process according to claim 1, wherein the accelerator (b3) is applied as a concentrated solution in the liquid curing agent (b2) in an amount of up to 55 weight %, based on the total weight of the concentrated solution of accelerator (b3) in the curing agent (b2) at room temperature.

6. The process according to claim 1, wherein said process is a resin transfer molding process (RTM).

7. The process according to claim 1, wherein injection of the thermosetting resin composition into the mold comprises varying the concentration of accelerator (b3) in the course of injecting the resin to increase the cure rate of the resin composition, wherein injection is initiated with a resin composition which contains no accelerator (b3) or the accelerator (b3) in a low concentration, and wherein injection is completed with a resin composition which contains the accelerator (b3) in a high concentration (VARICAT).

8. The process according to claim 7, wherein the resin composition which contains no accelerator (b3) or the accelerator (b3) in a low concentration comprises an amount of accelerator (b3) of from 0 to 0.75 weight %, based on the total weight of the thermosetting resin composition, and the resin composition which contains the accelerator (b3) in a high concentration comprises an amount of accelerator (b3) of from 0.75 to 5 weight %, based on the total weight of the thermosetting resin composition.

9. The process according to claim 7, wherein the liquid epoxy resin (b1) is a diglycidylether of bisphenol A, and the accelerator (b3) is p-toluene sulfonic acid, a liquid imidazolium salt of p-toluene sulfonic acid, or methane sulfonic acid.

10. The process according to claim 9, wherein the accelerator (b3) is p-toluene sulfonic acid, or a liquid imidazolium salt of p-toluene sulfonic acid.

11. The process according to claim 10, wherein the accelerator (b3) is p-toluene sulfonic acid, 1-methylimidazolium p-toluene sulfonate, or 1,3-dimethylimidazolium methyl sulfate.

12. The process according to claim 1, wherein curing is carried out under isothermal conditions at a temperature of from 80 to 140° C.

13. Composite articles obtained by the process according to claim l.

14. Use of the composite articles according to claim 13 for the construction of mass transportation vehicles, in particular in automotive and aerospace industry.
